(19) United States
(12) Patent Application Publication
(10) Pub. No.: US 2008/0318519 A1
(43) Pub. Date: Dec. 25, 2008

(54) Wireless network system and relay node

(75) Inventor: Ryo Iwasaki, Sendai-shi (JP)

Correspondence Address: OLIFF & BERRIDGE, PLC, P.O. BOX 320850, ALEXANDRIA, VA, 22320-4850, US

(73) Assignee: NEC TOKIN CORPORATION, Sendai-shi (JP)

(21) Appl. No.: 12/155,515

(22) Filed: Jun. 5, 2008

(30) Foreign Application Priority Data
Jun. 25, 2007 (JP) 2007-166210

(51) Int. Cl. H04B 7/14

(52) U.S. Cl. 455/7

(57) ABSTRACT

A wireless network system includes a fixed node, a relay node, and a moving body. The fixed node includes a radio communication section for transmitting/receiving information. The relay node includes a radio communication section for transmitting/receiving the information, an information recording section for storing the information received from the fixed node, and an information conveying section for determining a destination of the information. The moving body moves the relay node.

### BACKGROUND OF THE INVENTION

1. Field of the Invention

The present invention relates to a wireless network system that allows communications between wireless nodes, which are fixedly installed, via a wireless relay node.

2. Description of Related Art

A wireless network allows transmission/reception of information using a plurality of wireless nodes. In general, in the wireless network, wireless relay nodes (hereinafter, referred to as “relay node”) are installed between wireless nodes (hereinafter, referred to as “fixed node”) which are spaced apart from each other beyond each communicable range and which are fixedly installed, or fixed nodes are wire-connected to each other, thereby enabling long distance communication between the fixed nodes installed at locations spaced apart from each other.

FIG. 6 is a diagram for explaining a wireless network system of a related art using fixed nodes and relay nodes as wireless nodes.

Areas surrounded by the dashed lines of FIG. 6 represent communicable ranges of the wireless nodes. Between fixed nodes 1 and 2 having communicable ranges that do not overlap each other, relay nodes 6a, 6b, and 6c are arranged so that the adjacent wireless nodes are positioned within each of the communicable ranges.

When the fixed node 1, which transmits/receives information to/from an information source (not shown) with or without wires, transmits information to the fixed node 2, the fixed node 1 first transmits the information to the relay node 6a positioned within the communicable range of the fixed node 1. Then, the relay node 6a transmits the information to the relay node 6b positioned within the communicable range of the own node. In a similar manner, via the relay node 6b and 6c, the information is received by the fixed node 2. Thus, it is possible to transmit/receive information between the fixed nodes 1 and 2 having communicable ranges that do not overlap each other.

Japanese Unexamined Patent Application Publication No. 10-341243, for example, discloses a method in which a plurality of wireless nodes are installed in the above-mentioned manner to provide wide range communication service to users distributed geographically, by using multi-hop communications between the wireless nodes.

In the wireless network system as described above, it is necessary to install more relay nodes according to a distance between the fixed nodes. Accordingly, installation costs for the relay nodes may be increased. Further, as the number of the relay nodes is increased, reliability of data communications may be deteriorated.

There is also known a method of connecting the fixed nodes to each other via communication cables. However, installation costs for the communication cables and man-hours have to be taken into consideration also in this case.

### SUMMARY OF THE INVENTION

It is an object of the present invention to provide a wireless network system capable of transmitting information with simplicity and reliability in communications between fixed nodes installed beyond each communicable range.

In one aspect of the present invention, in order to cover a space between communicable ranges of fixed nodes installed at locations spaced apart from each other, a wireless network system has features that a relay node is allowed to move between the fixed nodes. Specifically, in the one aspect of the present invention, by allowing the relay node to move, communications between the fixed nodes can be established with reliability, without the need of arranging a large number of relay nodes between the fixed nodes and without wire-connecting the fixed nodes via communication cables.

In other words, the wireless network system according to the one aspect of the present invention includes a fixed node, a relay node, and moving body. The fixed node includes first transmission/reception means for transmitting/receiving information. The relay node includes: second transmission/reception means for transmitting/receiving the information; storage means for storing the information received from the fixed node; and determination means for determining a destination of the information. The moving means moves the relay node. In the wireless network system thus constructed, information transmitted from the fixed node is received by the relay node, and the relay node is allowed to move into a communicable range of another fixed node by means of being mounted on a vehicle, for example, to thereby transmit the information to the another fixed node. By repeating such operations, information transmission can be carried out between the fixed nodes having communicable ranges that do not overlap each other.

The wireless nodes herein described as the fixed node or the relay node each indicate a computer located on a network, a device including a dedicated integrated circuit (IC) having a communication protocol processing function, a base station, or the like. Note that those wireless nodes may belong to a plurality of wireless or wired networks at one time.

Radio communication sections 3 and 4 described hereinafter each correspond to the first transmission/reception means. A radio communication section 7 described hereinafter corresponds to the second transmission/reception means. For example, the radio communication sections 3 and 4 each include a wireless module including an antenna, and a radio transmission/reception circuit.

An information recording section 8 described hereinafter corresponds to the storage. For example, the information recording section 8 includes a memory such as a RAM, a hard disk, or a recording medium.

A moving body described hereinafter corresponds to the moving means. The moving body is an object that can be moved by oneself or by others, that is, for example, a vehicle, an electric train, a ship, an airplane, a human, or an animal.

An information conveying section 8 described hereinafter corresponds to the determination means. The information conveying section 8 is, for example, a computer or of an IC with a calculation function.

In other words, according to the present invention, there can be provided a wireless network including: a first wireless node including first transmission/reception means for transmitting/receiving information; a second wireless node including second transmission/reception means for transmitting/receiving the information, storage means for storing the information received from the first wireless node, and determination means for determining a destination of the information; and moving means for moving the second wireless node.

Note that the first wireless node may be fixedly installed.

The information may contain information on the destination.

According to the present invention, communications can be stably established between wireless nodes installed at locations spaced apart from each other beyond each communicable range, without the need of arranging a large number of wireless information relay nodes.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a diagram for explaining a basic structure of a wireless network system according to an embodiment of the present invention;

FIG. 2 is a diagram for explaining information transmission from a fixed node to a relay node according to the embodiment of the present invention;

FIG. 3 is a diagram for explaining information transmission from a relay node to a fixed node according to the embodiment of the present invention;

FIGS. 4A and 4B are diagrams for explaining the wireless network system according to the embodiment of the present invention, in which FIG. 4A shows a state of receiving information and FIG. 4B shows a state of transmitting information;

FIGS. 5A and 5B are diagrams for explaining the wireless network system according to the embodiment of the present invention, in which FIG. 5A shows a state of receiving information and FIG. 5B shows a state of transmitting information; and

FIG. 6 is a diagram for explaining a wireless network system of a related art.

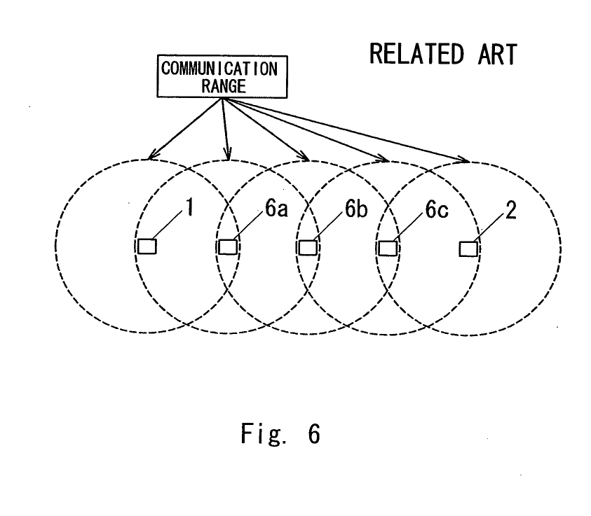

### DESCRIPTION OF THE PREFERRED EMBODIMENTS

A wireless network system according to an embodiment of the present invention includes a plurality of fixed nodes, a moving body, and a relay node. Each of the fixed nodes receives information from the outside through a radio communication section such as an antenna module, and transmits the information to another wireless node. The moving body moves between the plurality of fixed nodes, and moves across communicable ranges of the fixed nodes. The relay node is mounted on the moving body.

The relay node includes a radio communication section, an information recording section, and an information conveying section. The information conveying section transmits information between the radio communication section and the information recording section and determines a destination of the information. The relay node receives information from one of the fixed node through the radio communication section, and stores the received information in the information recording section through the information conveying section. Then, the relay node transmits the information stored in the information recording section to another fixed node through the radio communication section.

Information for specifying another fixed node as an information destination is contained in the information transmitted by the fixed node which serves as an information source. The relay node temporarily stores the information received from the fixed node in the information recording section. When the relay node transmits the information to another fixed node, the information conveying section reads the information stored in the information recording section, and determines whether the another fixed node is a valid destination.

The relay node is mounted on a moving body such as a vehicle. When the moving body enters a communicable range of a specific fixed node, the relay node receives information from the fixed node. The information conveying section of the relay node stores the received information in the information recording section, and refers to the received information to determine another fixed node as the destination. When the moving body enters a communicable range of the another fixed node serving as the destination, the information conveying section of the relay node mounted on the moving body operates to read the received information from the information recording section. Then, the information conveying section transmits the information to the another fixed node serving as the destination, through the radio communication section. The another fixed node operates in the same manner as the specific fixed node serving as the information source, and further transmits the information to still another fixed node.

Note that the destination of the information transmitted by the specific fixed node is not necessarily limited to one fixed node. In other words, the relay node mounted on the moving body may transmit the same information to a plurality of fixed nodes. Similarly, the relay node mounted on the moving body may carry pieces of information for the plurality of fixed nodes.

Hereinafter, a description is given of specific application examples of the wireless network system according to the embodiment of the present invention.

### APPLICATION EXAMPLE 1

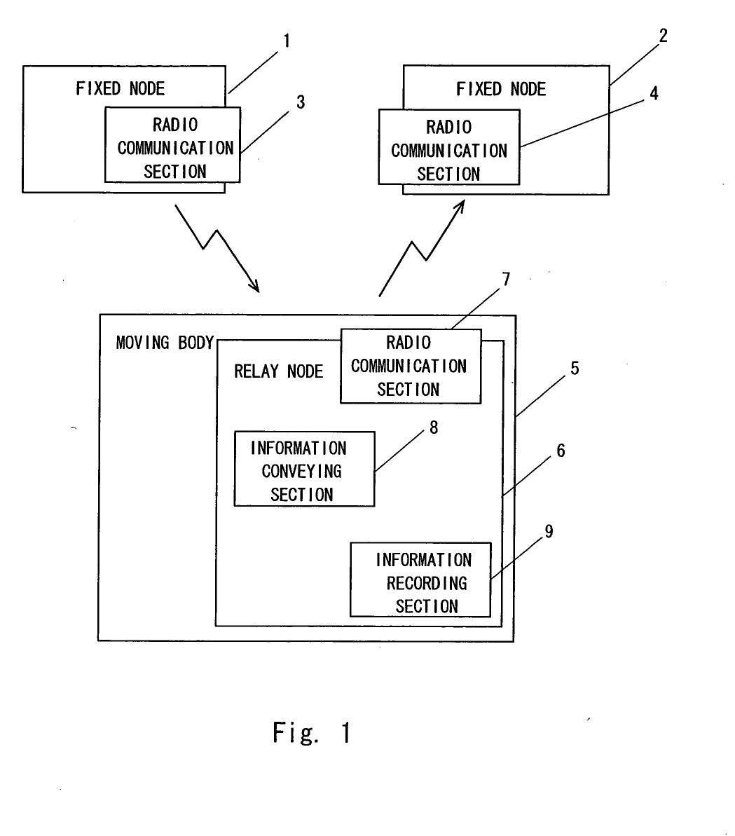

FIG. 1 is a diagram for explaining a basic structure of a wireless network system according to Application Example 1 of the present invention. FIG. 1 illustrates a case where two fixed nodes are provided.

A fixed node 1 includes a radio communication section 3 including an antenna module. Similarly, a fixed node 2 includes a radio communication section 4 including an antenna module. Communicable ranges of the fixed nodes 1 and 2 do not overlap each other, which makes it impossible to establish direct wireless communication therebetween. A moving body 5 moving between the fixed node 1 and the fixed node 2 includes a relay node 6 mounted thereon. The relay node 6 includes a radio communication section 7, an information conveying section 8, and an information recording section 9. Note that the fixed node 1 and the fixed node 2 each include equipment functioning as a so-called base station.

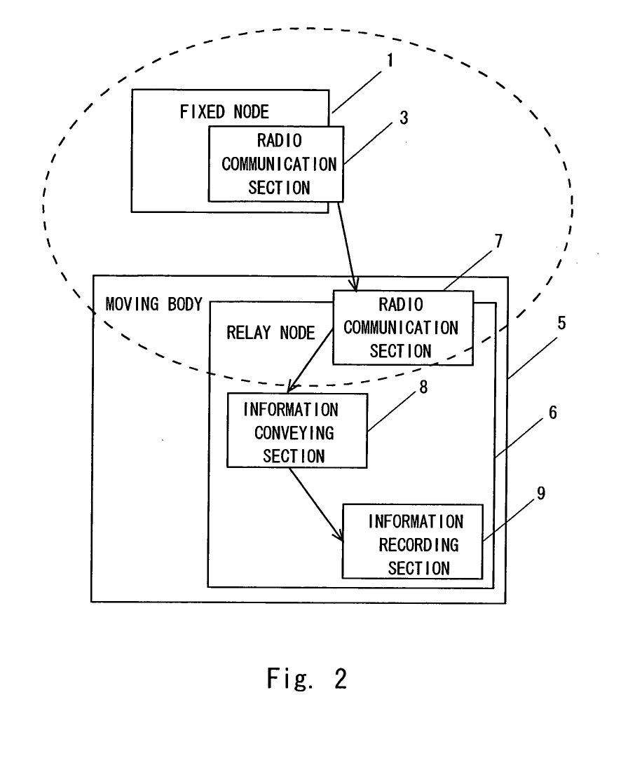

FIG. 2 is a diagram for explaining information transmission from the fixed node 1 to the relay node 6 according to Application Example 1. An area surrounded by the dashed line of FIG. 2 represents the communicable range of the fixed node 1.

In the communicable range of the fixed node 1, the relay node 6 receives information from the fixed node 1 through the radio communication section 3 and through the radio communication section 7. The relay node 6 stores the information in the information recording section 9 through the information conveying section 8. The information contains information on the destination of the information, for example, positional information on the fixed node 2 and information for identifying the fixed node 2. Along with the movement of the moving body 5, the relay node 6 moves into the communicable range of the fixed node 2.

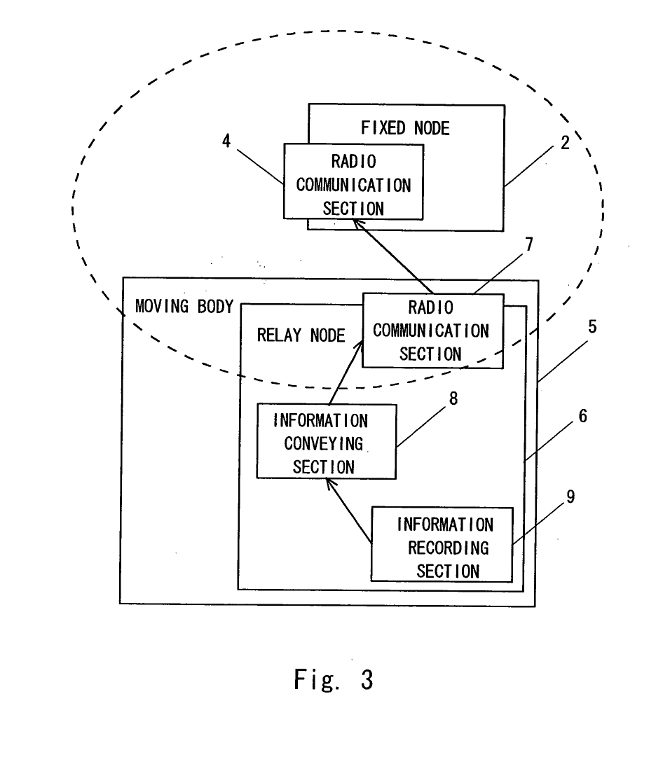

FIG. 3 is a diagram for explaining information transmission from the relay node 6 to the fixed node 2 according to Application Example 1. An area surrounded by the dashed line of FIG. 3 represents the communicable range of the fixed node 2.

Functions of the information conveying section 8 allow the relay node 6 to determine the fixed node 2 as the destination of the information received from the fixed node 1. When the relay node 6 moves into the communicable range of the fixed node 2, the relay node 6 confirms the presence of the fixed node 2 in the communicable range of the fixed node 2, and reads the information from the information recording section 9. Then, the relay node 6 transmits the information to the fixed node 2 through the radio communication section 7 and through the radio communication section 4.

After that, the relay node 6 deletes the information transmitted to the fixed node 2, from the information recording section 9, as needed.

Note that the relay node 6 confirms the presence or absence of the information to be transmitted to the fixed node 2 in the communicable range of the fixed node 2. When the information to be transmitted is not present, the above-mentioned processing is not carried out.

### APPLICATION EXAMPLE 2

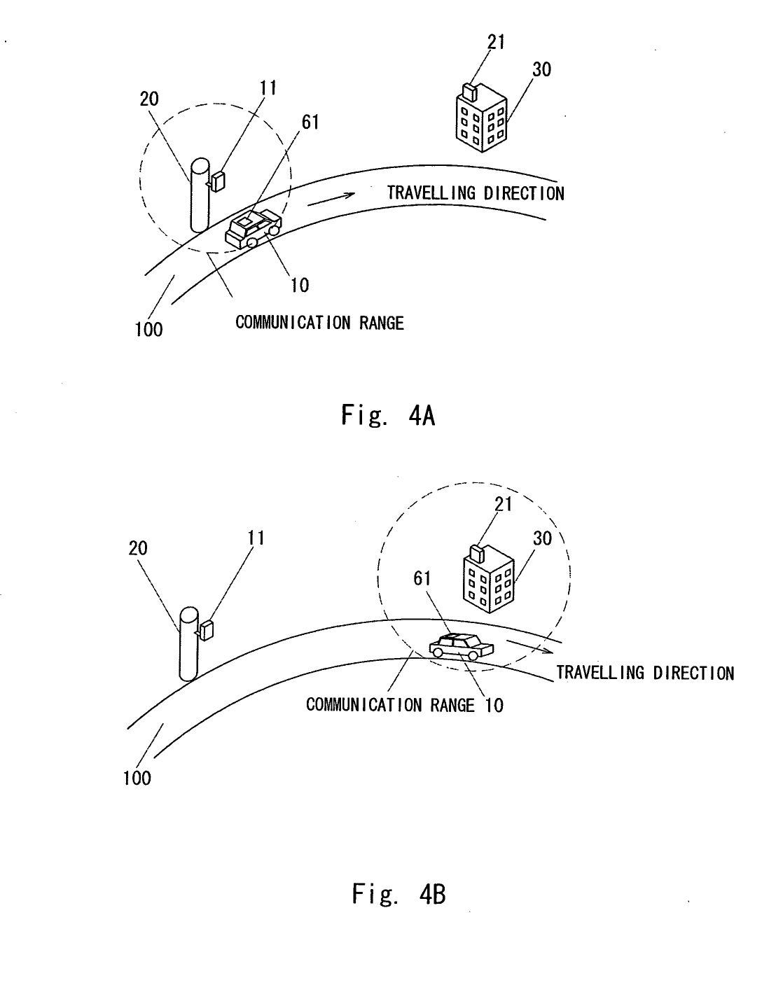

FIGS. 4A and 4B are diagrams for explaining a wireless network system according to Application Example 2 of the present invention. FIG. 4A shows a state of receiving information, and FIG. 4B shows a state of transmitting information.

A vehicle 10, which is an example of the moving body, includes a relay node 61 mounted thereon, and travels along a road 100 at a speed of 60 km/h. When the vehicle 10 enters a communicable range of a fixed node 11 installed on a pole 20, communication between the relay node 61 and the fixed node 11 is started. The communicable range of the fixed node 11 is indicated by the dashed line of FIG. 4A and within a 1-kilometer radius with the pole 20 as a center. The communication between the fixed node 11 and the relay node 61 is completed before the vehicle 10 exits the communicable range of the fixed node 11. In this case, the relay node 61 receives, from the fixed node 11, destination information indicating that the destination is a fixed node 21.

Then, the vehicle 10 continues travelling along the road 100 and enters a communicable range of the fixed node 21 installed on a building 30. The communicable range of the fixed node 21 is indicated by the dashed line of FIG. 4B and within a 1-kilometer radius with the building 30 as a center. At this time, communication between the relay node 61 mounted on the vehicle 10 and the fixed node 21 is started. The relay node 61 determines the information received from the fixed node 11 as the information to be transmitted to the fixed node 21, and transmits the information to the fixed node 21. Note that the transmission is completed before the vehicle 10 exits the communicable range of the fixed node 21.

### APPLICATION EXAMPLE 3

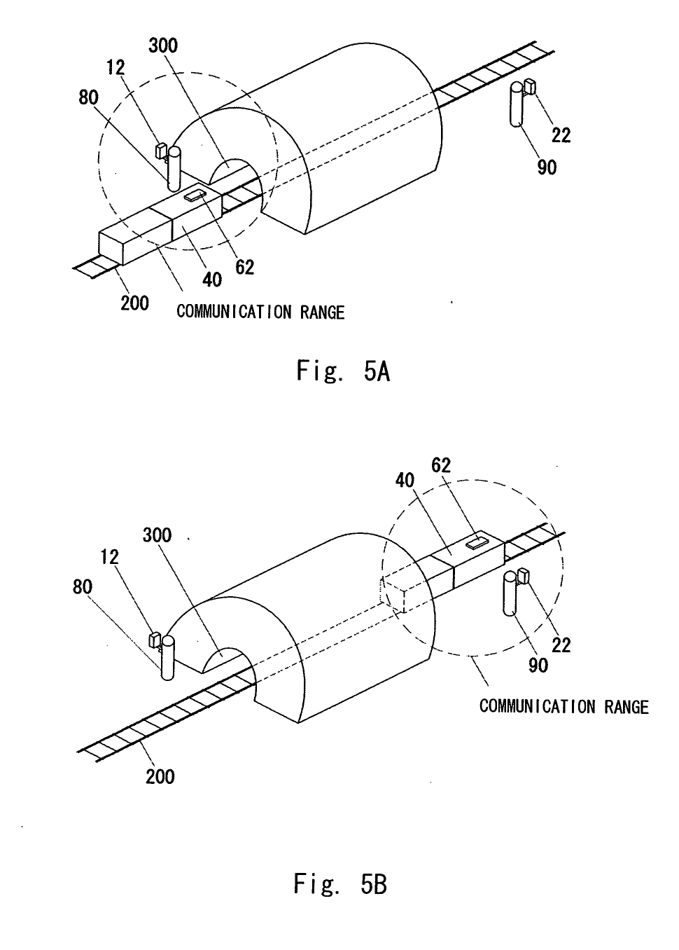

FIGS. 5A and 5B are diagrams for explaining a wireless network system according to Application Example 3 of the present invention. FIG. 5A shows a state of receiving information, and FIG. 5B shows a state of transmitting information.

An electric train 40, which is an example of the moving body, includes a relay node 62 mounted thereon, and travels along a track 200 at a speed of 100 km/h. When the electric train 40 enters a communicable range of a fixed node 12 installed on a pole 80, communication between the relay node 62 and the fixed node 12 is started. The communicable range of the fixed node 12 is indicated by the dashed line of FIG. 5A and within a 1-kilometer radius with the pole 80 as a center. The communication between the fixed node 12 and the relay node 62 is completed before the electric train 40 exits the communicable range of the fixed node 12. At this time, the relay node 62 receives, from the fixed node 12, destination information indicating that the destination is a fixed node 22.

Then, the electric train 40 continues travelling along the track 200 through a tunnel 300, and enters a communicable range of the fixed node 22 installed on a pole 90. The communicable range of the fixed node 22 is indicated by the dashed line of FIG. 5B and within a 1-kilometer radius with the pole 90 as a center. At this time, communication between the relay node 62 mounted on the electric train 40 and the fixed node 22 is started. The relay node 62 determines the information received from the fixed node 12 as the information to be transmitted to the fixed node 22, and transmits the information to the fixed node 22. Note that the communication is completed before the electric train 40 exits the communicable range of the fixed node 22.

The embodiments of the present invention have been described above by illustrating specific application examples, but the present invention is not limited to the application examples. Design variations of the present invention may be made without departing from the gist of the present invention. In other words, the present invention includes any variations and modifications ordinarily made by those skilled in the art, as a matter of course.

What is claimed is:

1. A wireless network system, comprising:
a first wireless node including first transmission/reception means for transmitting/receiving information;
a second wireless node including:
second transmission/reception means for transmitting/receiving the information;
storage means for storing the information received from the first wireless node; and
determination means for determining a destination of the information; and
moving means for moving the second wireless node.

2. The wireless network system according to claim 1, wherein the first wireless nodes are fixedly installed.

3. The wireless network system according to claim 1, wherein the information contains information on the destination.

4. A wireless network system, comprising:
a source node having a radio communication function;
a destination node having a radio communication function and arranged to be geographically spaced apart from the source node beyond a range in which direct radio communication between the source node and the destination node is possible; and
a relay node mounted on a moving body and relaying information transferred from the source node to the destination node,
wherein the relay node comprises:
a radio communication section capable of radio communication with the source node and the destination node;
an information recording section; and
an information conveying section receiving the information from the source node through the radio communication section and storing the received information in the information recording section when the relay node is positioned in a radio communicable range of the source node, and transmitting the information read from the information recording section through the radio communication section when it is detected that the relay node reaches a radio communicable range of the destination node along with movement of the moving body.

5. A relay node mounted on a moving body and relaying information transferred from a source node to a destination node, the relay node comprising:
a radio communication section capable of radio communication with the source node and the destination node;
an information recording section; and
an information conveying section receiving the information from the source node through the radio communication section and storing the received information in the information recording section when the relay node is positioned in a radio communicable range of the source node, and transmitting the information read from the information recording section to the destination node through the radio communication section when it is detected that the relay node reaches a radio communicable range of the destination node along with movement of the moving body.
